(19) United States
(12) Patent Application Publication
(10) Pub. No.: US 2008/0088739 A1
(43) Pub. Date: Apr. 17, 2008

(54) USB hub with a TV receiver

(75) Inventor: Robert Wang, Taoyuan (TW)

Correspondence Address: BRUCE H. TROXELL, 5205 LEESBURG PIKE, SUITE 1404, FALLS CHURCH, VA, 22041, US

(73) Assignee: CERAMATE TECHNICAL CO., LTD.

(21) Appl. No.: 11/580,300

(22) Filed: Oct. 13, 2006

(51) Int. Cl. H04N 5/44

(52) U.S. Cl. 348/553; 348/E05.096

(57) ABSTRACT

An USB HUB with a TV receiver is provided mainly with a TV module that is able to shift a wireless signal received into a TV signal. Which is then transmitted to an electronic appliance connected with the USB HUB, achieving a purpose of miniaturization for saving space.

### BACKGROUND OF THE INVENTION

1. Field of the Invention

This invention relates to an USB HUB, particularly to one provided with a TV module able to shift a wireless signal received into a TV signal.

2. Description of the Prior Art

As shown in FIG. 1, an USB interface, a technique us e d to simplify connection s between a computer and its peripherals, is applied for all kinds of electronic appliances because of its advantages of plug-and-play, hot attach & detach, and quick transmission. But, the number of the USB interfacial sockets installed in an electronic appliance is always limited so that an conventional USB HUB 1 is needed to connect with the USB interface socket to give more USB interface sockets 2. Also, if an external TV receiver with an USB interface is plugged in an USB interfacial socket of an electronic appliance, the number of sockets is to be lessened for other connections, and if the external TV receiver is plugged in a socket of the conventional USB HUB connected with the electronic appliance, it is to occupy too much space.

### SUMMARY OF THE INVENTION

The objective of this invention is to offer an USB HUB with a TV receiver.

The main characteristic of the invention is a TV module provided in the USB HUB that is able to shift a wireless signal received into a TV signal, which is then transmitted to an electronic appliance.

### BRIEF DESCRIPTION OF DRAWINGS

This invention is better understood by referring to the accompanying drawings, wherein:

FIG. 1 is a perspective view of a conventional USB HUB;

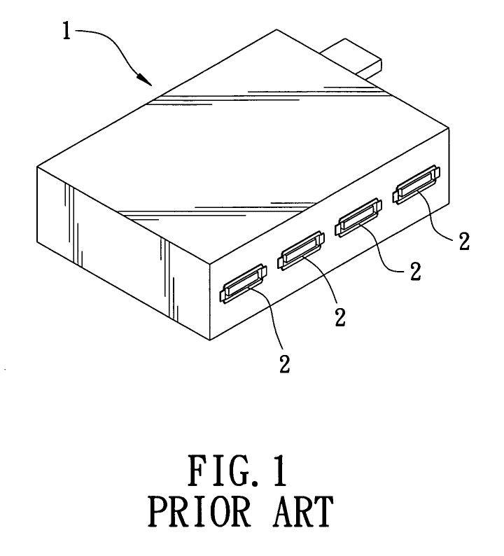

FIG. 2 is a perspective view of a first preferred embodiment of an USB HUB with a TV receiver in the present invention;

FIG. 3 is a block diagram of an electric circuit of the USB HUB with a TV receiver in the present invention; and

FIG. 4 is a perspective view of a second preferred embodiment of an USB HUB with a TV receiver in the present invention.

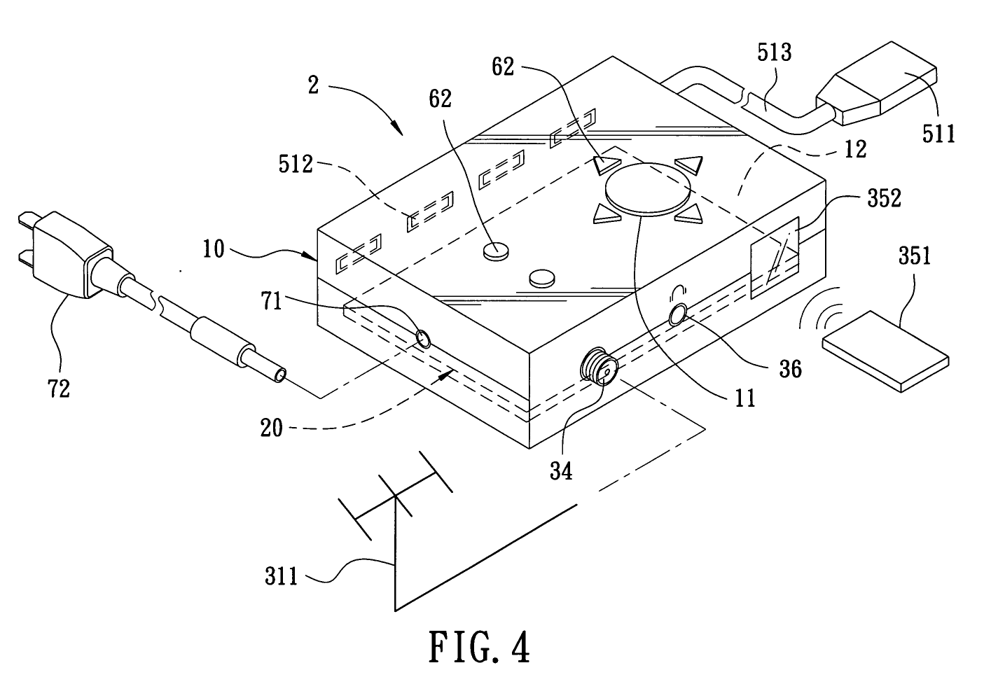

### DETAILED DESCRIPTION OF THE PREFERRED EMBODIMENT

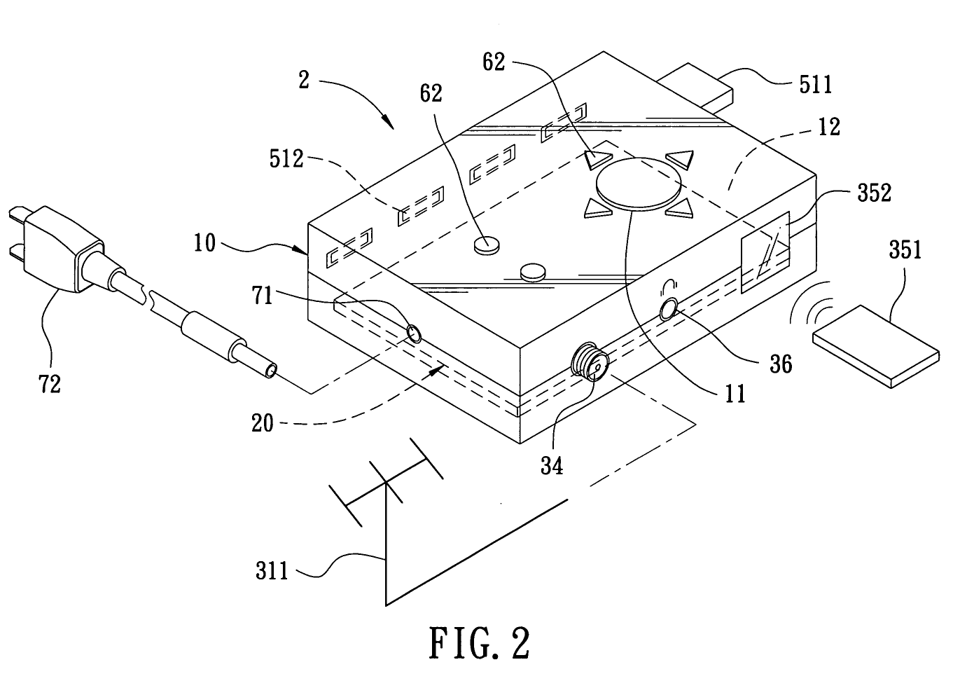

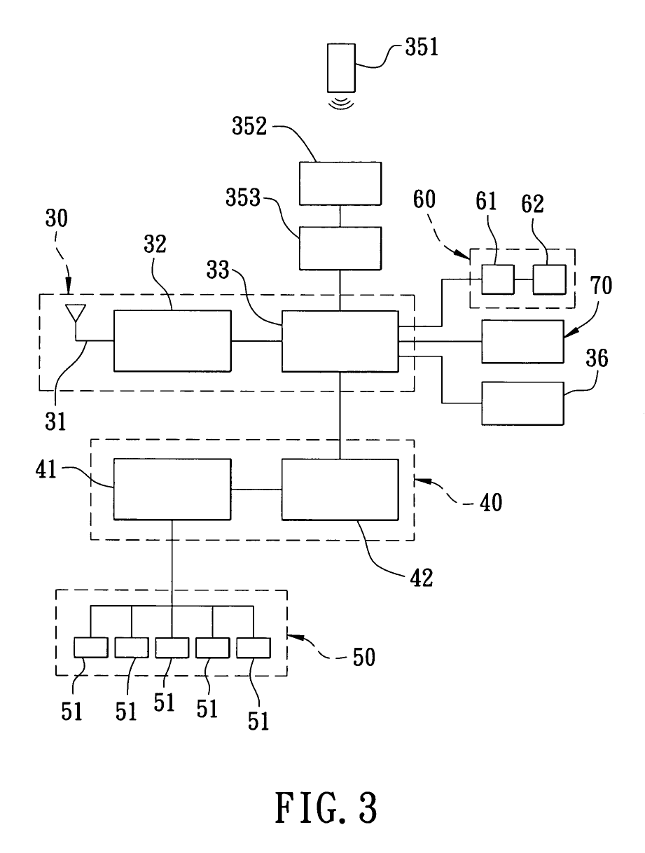

As shown in FIGS. 2 and 3, a preferred embodiment of a USB HUB with a TV receiver 2(3) in the present invention includes a case 10, a PC board 20, a TV module 30, a USB control unit 40, a connecting unit 50, a panel controlling unit 60 and a power circuit 70.

The case 10 is provided with plural openings 11 bored at preset locations and an accommodating chamber 12 inside it.

The PC board 20 is installed in the accommodating chamber 12 of the case 10.

The TV module 30 fixed properly on the PC board 20 is provided with an antenna unit 31, a tuning unit 32 connected with the antenna unit 31 to receive wireless signals, a digital image processing unit 33 connected with one end of the tuning unit 32, an auxiliary antenna socket 34 connected with the antenna unit 31 for being plugged by an external antenna 311, a remote-controlled unit 35 connected with the digital image processing unit 33, and an audio output socket 36 fixed in one of the openings 11 for connecting with the digital image processing unit 33. The antenna unit 31 is a printed circuit antenna of copper foil printed on the PC board 20, and can also be a micro antenna fixed on the PC board 20. The remote-controlled unit 35 is composed of a remote-controlled signal emitter 351, a remote-controlled signal receiver 352 and a control loop 353. The control loop 353, an infrared control loop set properly on the PC board 20, is connected with the digital image processing unit 33 by its one end and the remote-controlled signal receiver 352 by the other end. The remote-controlled signal receiver 352 fixed in one of the openings 11 is connected with the control loop 353.

The USB controlling unit 40 fixed properly on the PC board 20 is provided with a USB HUB control IC 41 and a USB control interface 42 that is connected with the digital image processing unit 33 of the TV module 30 by its one end and the USB HUB control IC 41 by the other end.

The connecting unit 50 provided with plural USB connecting devices 51 is fixed on the PC board 20 to connect with the USB HUB control IC 41 of the USB controlling unit 40 by its one side and fixed in some of the openings 11 of the case 10 by another side for connecting with other peripherals. One of the USB connecting devices 51 is an USB male plug 511 for connecting with an electronic appliance and the rest are female sockets 512 used as USB interfacial sockets.

The panel controlling unit 60 is provided with a panel processor 61 fixed properly on the PC board 20 to connect with the digital image processing unit 33 of the TV module 30, and plural control switches 62 fixed in one of the openings 11 and connected with the panel processor 62.

The power loop 70 is fixed properly on the PC board 20 to connect with the TV module 30 for supplying various voltage modes for the invention, and connected with an external power socket 71.

In using, as shown in FIGS. 2 3, when TV signal is hoped to be received, a user has to select TV channel and preset functions wanted via turning on the control switches 62, so that the remote-controlled signal emitter 351 is to send a control signal to the remote-controlled signal receiver 352 for transmitting to the control loop 353 to control the TV module 30 to receive the desired TV channel and preset functions. The TV module 30 receives wireless signal by means of the antenna unit 31 that can be intensified by plugging the external antenna 311 in the auxiliary antenna socket 34 to receive signal intensively if receiving badly. Then, the TV module 30 is to alter the wireless signal into TV signal that is to be transmitted by the USB controlling unit 40, and next, to the electronic device connected with the USB male plug 511 of the connecting unit 50 for showing TV program. If power is insufficient to meet several connections of the USB interfaces, the external power socket 71 of the power loop 70 can be connected with an external power 72 to supply power needed.

As shown in FIG. 5, a second preferred embodiment of USB HUB with a TV receiver in the present invention has the same parts as the first one does except that the USB male plug 511 is connected with an additional extended line 513 to connect with an electronic appliance.

The invention has the following advantages as can be seen from the foresaid description.

1. The invention contains the TV module provided with an antenna unit having a printed circuit antenna on the PC board that is able to receive TV signal intensively by connecting the external antenna in the auxiliary antenna socket.

2. The invention can not only increase USB interfacial sockets, but also receive a TV signal, achieving a purpose of miniaturization for saving space.

While the preferred embodiment of the invention has been described above, it will be recognized and understood that various modifications may be made therein and the appended claims are intended to cover all such modifications that may fall within the spirit and scope of the invention.

What is claimed is:

1. An USB HUB with a TV receiver comprising:
a case provided with plural openings bored at preset locations and an accommodating chamber formed inside it;
a PC board installed in said accommodating chamber of said case;
a TV module fixed properly on said PC board;
a USB controlling unit fixed properly on said PC board and connected with said TV module;
a connecting unit provided with plural USB connecting devices and fixed on said PC board to connect with said USB controlling unit by its one side and fixed in some of said openings of said case by another side for connecting with other peripherals;
a panel controlling unit provided with a panel processor fixed properly on said PC board to connect with said TV module, and plural control switches fixed in one of said openings of said case and connected with said panel processor; and
a power loop fixed properly on said PC board to connect with said TV module.

2. An USB HUB with a TV receiver as claimed in claim 1, wherein said TV module is provided with an antenna unit, a tuning unit and a digital image processing unit, said tuning unit connected with said antenna by its one end to receive a wireless signal and connected with said digital image processing unit by the other end.

3. An USB HUB with a TV receiver as claimed in claim 2, wherein said antenna unit is a printed circuit antenna with copper foil printed on said PC board.

4. An USB HUB with a TV receiver as claimed in claim 2, wherein said antenna unit is a micro antenna fixed on said PC board.

5. An USB HUB with a TV receiver as claimed in claim 2, wherein said antenna unit is connected with an auxiliary antenna socket fixed in one of said openings of said case to connect with an external antenna.

6. An USB HUB with a TV receiver as claimed in claim 1, wherein said TV module is provided with an audio output socket fixed in one of said openings of said case.

7. An USB HUB with a TV receiver as claimed in claim 1, wherein said TV module is provided with a remote-controlled unit.

8. An USB HUB with a TV receiver as claimed in claim 1, wherein said remote-controlled unit is provided with a remote-controlled signal emitter, a remote-controlled signal receiver and a control loop, said control loop fixed properly on said PC board to connect with said digital image processing unit by its one end and said remote-controlled signal receiver by the other end, said remote-controlled signal receiver fixed in one of said openings of said case to receive signal from said remote-controlled signal emitter.

9. An USB HUB with a TV receiver as claimed in claim 7, wherein said control loop is an infrared remote-controlled loop.

10. An USB HUB with a TV receiver as claimed in claim 1, wherein said USB controlling unit is provided with an USB HUB control IC and an USB control interface that is connected with said TV module by its one end and said USB HUB control IC by the other end to connect with said connecting unit.

11. An USB HUB with a TV receiver as claimed in claim 1, wherein said USB controlling devices are any combination of an USB male plug and an USB female socket.

12. An USB HUB with a TV receiver as claimed in claim 1, wherein at least one of said USB controlling devices is said USB male plug.

13. An USB HUB with a TV receiver as claimed in claim 12, wherein said USB male head is connected with an extended line for connecting with said USB controlling unit.

14. An USB HUB with a TV receiver as claimed in claim 1, wherein said power loop is provided with an external power socket fixed in one of said openings of said case.
